(19) United States
(12) Patent Application Publication
(10) Pub. No.: US 2008/0223469 A1
(43) Pub. Date: Sep. 18, 2008

(54) MULTIPLE CONDUIT-REPAIR METHOD

(76) Inventor: Hillel David Renassia, Caesarea (IL)

Correspondence Address: DR. MARK M. FRIEDMAN;C/O BILL POLKINGHORN - DISCOVERY DISPATCH, 9003 FLORIN WAY, UPPER MARLBORO, MD, 20772, US

(21) Appl. No.: 11/847,347

(22) Filed: Aug. 30, 2007

Related U.S. Application Data
(60) Provisional application No. 60/894,462, filed on Mar. 13, 2007.

(51) Int. Cl. F16L 55/16

(52) U.S. Cl. 138/98; 138/97; 405/150.1; 405/184.2

(57) ABSTRACT

A method for repairing multiple conduits using a vacuum collapsed, elastic liner involves providing a quantity sufficient for multiple repairs to the work sight and inserting a length into the damaged conduit. The protruding liner is then heat-sealed to prevent volume flow between the inserted liner and the remaining liner. The inserted liner vacuum is broken enabling the inserted liner to reassume its original size and shape. In doing so the expanded liner seals the problematic breeches. A retaining sleeve is then inserted in the expanded liner to hold it in place.

### FIELD AND BACKGROUND OF THE INVENTION

The present invention relates to conduits and, in particular, it is concerned with a method for repairing damaged conduits.

It is known that conduits develop leaks requiring repair or replacement. Frequently the conduits are inaccessible, or if they are accessible, require expensive, time-consuming excavation work causing great inconvenience to people trying to function in the vicinity. A number of in situ technologies have been developed to address these difficulties. U.S. Pat. No. 6,299,803B1 discloses a method for producing a liner whose diameter is reduced temporarily until the liner is situated in the damaged conduit. A vacuum pump is used to reduce the air pressure inside an elastic, polymer pipe sealed at one end. The air pressure is reduced until the liner walls buckle and collapse. Then sealing the liner at the second end preserves the relative vacuum and the desired collapsed state. After the liner is situated in the damaged conduit, the vacuum is broken allowing the liner to expand so that it conforms to the contours of the inner surface of the conduit wall and covers its breaches. The shortcoming of such this technology is that each repair, with its unique size and set of conditions, requires a liner custom ordered to fit the repair. Many times the circumstances dictating the liner parameters are unknown until the work crew arrives at the site or a first repair reveals a need for additional repairs, each with their unforeseen requirements. Lost work time and added transportation expenses incurred from working on a custom order basis make the method economically non-optimal.

UK patent application GB 2406889A discloses a similar vacuum-collapsed liner repair method. This patent further discloses a storage and transportation method for large quantities of vacuum collapsed liner. The ends of a single length sufficient for multiple repairs is sealed and rolled onto a drum. There is a need for an installation method that facilitates quick and easy removal of the required liner length from the liner supply while preserving the vacuum in the remaining liner.

### SUMMARY OF THE INVENTION

The present invention is a method for repairing damaged conduits.

According to the teachings of the present invention there is provided, a method for repairing damaged conduits comprising: (a) providing a stored length of elastic, vacuum-collapsed liner, the vacuum-collapsed liner having a collapsed-state shape, and being biased towards an open shape on release of the vacuum, (b) inserting a first length of the liner through a portion of damaged conduit for a first repair, (c) sealing the liner to prevent flow between an inner volume of the first length and an inner volume of a remaining part of the liner, and (d) breaking the vacuum of the inner volume of the first length of liner inserted in the damaged conduit so that the inserted liner attempts to reassume open shape and the remaining liner remains in its the collapsed state.

According to a further feature of the present invention, the collapsed-state shape is a four-lobed shape.

According to a further feature of the present invention, the vacuum collapsed liner is provided on a reel.

According to a further feature of the present invention, the sealing is heat fusing.

According to a further feature of the present invention, a sleeve element is also inserted into the inserted liner, the sleeve element being configured to press the liner against the conduit.

### BRIEF DESCRIPTION OF THE DRAWINGS

The invention is herein described, by way of example only, with reference to the accompanying drawings, wherein:

FIG. 1 is an isometric view of a four-lobed, vacuum collapsed liner.

FIG. 2 is a cross sectional side view of a damaged conduit with a vacuum collapsed liner inserted before its vacuum has been broken.

FIG. 3. is a cross sectional side view of a damaged conduit with a vacuum collapsed liner inserted after the vacuum has been broken.

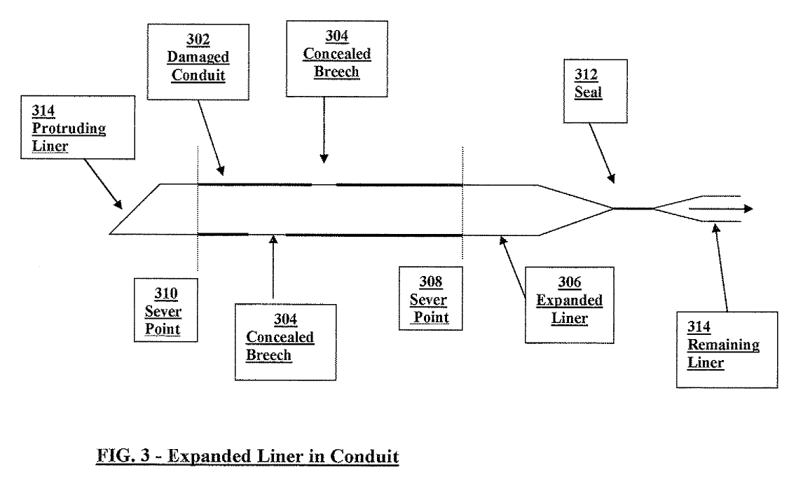

FIG. 4 is a cross sectional side view of a repaired conduit with a retaining element installed.

### DESCRIPTION OF THE PREFERRED EMBODIMENTS

The present invention is an installation method of a vacuum collapsed liner into a damaged conduit.

The principles and operation of the method according to the present invention may be better understood with reference to the drawings and the accompanying description.

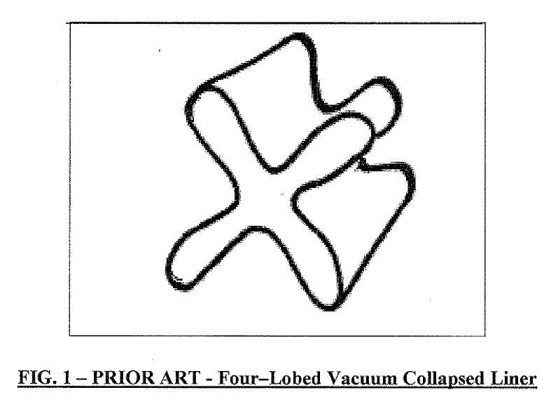

The method presented here within is based on an elastic, polymer pipe temporarily reduced in diameter. The size reduction is achieved by collapsing the pipe walls by decreasing the internal pipe pressure and then maintaining the collapsed state by sealing the pipe openings. The pipe collapses, for example, to a four-lobed shape, FIG. 1, and maintains that shape until its vacuum is broken, at which time it attempts to reassume its original size and circular perimeter. For a detailed account of the production methods and recommended polymer types, one may refer to U.S. Pat. No. 6,299,803B1 and UK patent application GB 2406889A The multi-conduit repair method includes the following general steps, providing liner to the worksite, inserting the liner, sealing the liner, breaking the vacuum, and applying a retainer.

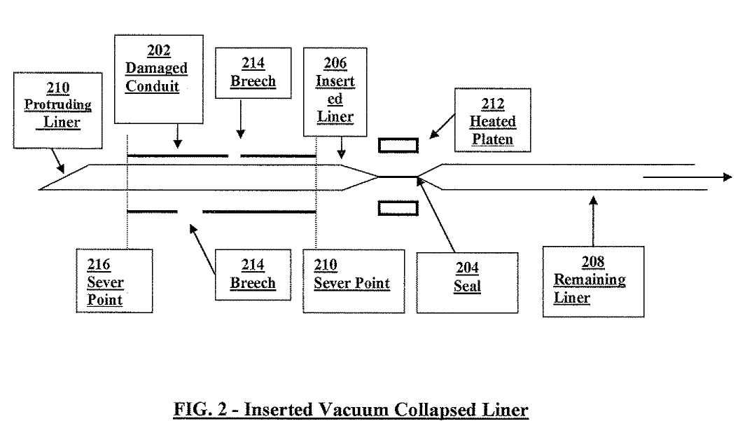

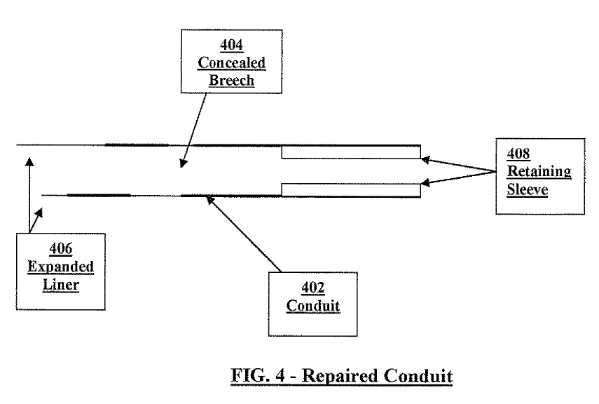

Referring to these steps in greater detail, the collapsed vacuum liner is provided to the work site, preferably on a reel, in quantities sufficient to perform multiple repairs. A range of liner diameters may also be provided to ensure a sufficient selection of liners so that the repair may be executed quickly and efficiently. At the work site the appropriate liner (FIG. 2) is inserted 206 through the damaged conduit 202 until the liner protrudes 210 from the far end of the damaged conduit 202. The liner walls are heat fused together, for example, by clamping the liner between two heated platens 212. The resulting seal 204 near the insertion point ensures the remaining liner 208 maintains its collapsed state when the inserted liner vacuum is broken. According to one preferred option, the sever point 210 is chosen to be flush with the end of the conduit to execute a tidy repair. The inserted liner vacuum is broken and the liner is disconnected from the remaining liner 208 by severing the inserted liner 206, preferably at sever point 210 so that the liner end lies flush with the conduit end. After the vacuum is broken, the liner expands 306 against the inner conduit wall and covers the problematic breeches 304 so as to seal them. The protruding liner 314 is then sliced off at sever point 310 adjacent to the conduit exit point. Alternatively, the protruding liner 210 may first be sliced off at sever point 216, thus breaking the vacuum and allowing the liner to expand and cover the problematic breaches 304. The expanded liner 306 is then disconnected from the remaining liner at sever point 308. In either case, retaining elements (FIG. 4) 408 configured to apply an outward radial bias against the conduit wall 402 are then inserted.

The disclosed method is not limited to a particular conduit size and may be employed with a large range of conduit sizes. Commonly the conduits discussed here within are circular pipes, however the conduits may also be gutters, troughs or any other transporter of liquids or gases.

It will be appreciated that the above descriptions are intended only to serve as examples, and that many other embodiments are possible within the scope of the present invention as defined in the appended claims.

What is claimed is:

1. A method for repairing damaged conduits comprising:
(a) providing a stored length of elastic, vacuum-collapsed liner, said vacuum-collapsed liner having a collapsed-state shape, and being biased towards an open shape on release of the vacuum,
(b) inserting a first length of said liner through a portion of damaged conduit for a first repair,
(c) sealing said liner to prevent flow between an inner volume of said first length and an inner volume of a remaining part of said liner, and
(d) breaking said vacuum of said inner volume of said first length of liner inserted in said damaged conduit so that said inserted liner attempts to reassume open shape and said remaining liner remains in its said collapsed state.

2. The method of claim 1, wherein said collapsed-state shape is a four-lobed shape.

3. The method of claim 1, wherein said vacuum collapsed liner is provided on a reel.

4. The method of claim 1, wherein said sealing is heat fusing.

5. The method of claim 1, further comprising inserting into said inserted liner a sleeve element configured to press said liner against said conduit.
